(19) United States
(12) Patent Application Publication
(10) Pub. No.: US 2003/0106848 A1
(43) Pub. Date: Jun. 12, 2003

(54) Relief valve for oil filter and oil filter

(75) Inventors: Yoshihiro Oohashi, Kariya-shi (JP); Tadashi Ogawa, Kariya-shi (JP)

Correspondence Address: OLIFF & BERRIDGE, PLC, P.O. BOX 19928, ALEXANDRIA, VA, 22320, US

(73) Assignees: Toyoda Boshoku Corporation, Kariya-shi (JP); Denso Corporation, Kariya-city (JP)

(21) Appl. No.: 10/265,397

(22) Filed: Oct. 7, 2002

(30) Foreign Application Priority Data
Oct. 11, 2001 (JP) 2001-314280

(51) Int. Cl. B01D 27/10

(52) U.S. Cl. 210/130

(57) ABSTRACT

A relief valve is provided with a valve seat, a valve body capable of closing an open portion of the valve seat , a coiled spring for energizing the valve body in a closing direction, and a spring receiving body disposed such that the spring is interposed between the spring receiving body and the valve seat. This spring receiving body has a pair of recess portions that can be fitted in end portions of a beam portion of the valve body. According to this relief valve, in an assembled state, if the valve body and the spring receiving body are brought into proximity and then rotated relative to each other, the valve body, the spring receiving body, the spring, and the valve seat, are rapidly disassembled.

The disclosure of Japanese Patent Application No. 2001-314280 filed on Oct. 11, 2001, including the specification, drawings and abstract is incorporated herein by reference in its entirety.

### BACKGROUND OF THE INVENTION

1. Field of Invention

The invention relates to a relief valve for an oil filter and an oil filter that filters foreign matter mixed within oil. In particular, the invention relates to a relief valve for an oil filter and an oil filter, which are easy for an operator to assemble and disassemble manually.

2. Description of Related Art

An oil filter has been known which has a filter body provided in a casing having an inflow port and an outflow port, which filters dust or the like within oil flowing in from the inflow port due to the effect of an oil pump, or the like, and discharges the filtered oil from the outflow port.

With oil filters such as this, in the case that the filter body is blocked to a given extent or more by dust, or the like, contained within the oil, or high-viscosity oil flows there within, the pressure difference between the upstream side and the downstream side of the filter body becomes extremely large. This pressure difference is a cause of damage, or the like, of the filter body. Accordingly, in order to avoid this problem, normally, a relief valve is provided that is both capable of separating the upstream side and the downstream side of the filter body and communicating both sides of the filter depending on the pressure difference between the upstream side and the downstream side as a by-pass.

An example of the aforementioned relief valve for an oil filter is disclosed in U.S. Pat. No. 3,807,561. The relief valve is provided with a valve seat having an open portion communicating an upstream side with a downstream side of the filter body, a valve body capable of closing the open portion, and a coiled spring capable of energizing the valve body in a closing direction. The valve body is provided with an integrated engagement hook portion close to a tip side of each of an elastically deformable column portion. The coiled spring is interposed between the engagement hook portion and the valve seat.

Furthermore, normally, in the relief valve, the open portion of the valve seat is closed by energizing force of the coiled spring. On the contrary, in the case that the pressure of the upstream side is much larger than that of the downstream side, the valve body is displaced in an opening direction resisting energizing force of the coiled spring, and the open portion of the valve seat is opened to discharge the oil.

Moreover, for example, a relief valve for an oil filter is disclosed in Published Japanese Translation of PCT application, JP-T-5-501827. The oil filter has a structure which is generally the same as the aforementioned relief valve and which is provided with two sets of column portions for the valve body. Each set of the column portions is composed of a pair of columns. The height dimensions of the columns of each set of column portions are set to different values. Even if the engagement hook portions of one of the column portions provided are damaged, the functions of the relief valve can be maintained by the engagement hook portions provided on the other columns.

Moreover, when assembling the relief valves disclosed in U.S. Pat. No. 3,807,561 and Published Japanese Translation of PCT application, JP-T-5-501,827, the engagement hook portions of the valve body and the support portions are inserted through the open portion of the valve seat. Following this, the coiled spring is pushed onto the column portion of the valve body from above, and as a result, the column portion is bent towards the center by the force exerted by the contact pressure of the engagement hook portions and the coiled spring. As a result, the valve body is fitted to the coiled spring. Accordingly, it is comparatively easy for the operator to manually conduct assembly. Furthermore, when disassembling the relief valves disclosed in U.S. Pat. No. 3,807,561 and Published Japanese Translation of PCT application, JP-T-5-501,827, the operator removes the coiled spring while forcibly bending the column portions by fingertip manipulation, and then conducts separation of the valve seat and valve body.

However, in the relief valve disclosed in the U.S. Pat. No. 3,807,561, the cross section area of the column portion is set to a comparatively large value and thus the operation of forcibly bending the column portion during disassembly is difficult. Moreover, the operation of removing the coiled spring without touching the engagement hook portions while maintaining a state in which the column portion is forcibly bent is extremely difficult. Namely, disassembly is time consuming because the engagement hook portion easily catches on the coiled spring during the removal of the coiled spring.

Moreover, in the relief valve disclosed in the Published Japanese Translation of PCT application, JP-T-5-501,827, the cross section area of each column portion is set to a comparatively small value, thus making each column portion easy to forcibly bend, as compared with the column portion of the relief valve disclosed in U.S. Pat. No. 3,807,561. However, since a larger number of column portions and engagement hook portions are provided, the engagement hook portions frequently catch on the coiled spring.

Recently, great emphasis is being placed on environmental countermeasures including recyclability for the vehicle design of automobiles, or the like. The oil filters employed in vehicles are not except from this, and, therefore, it is important to consider impacts thereof on the environment from material selection to separability during disposal.

### SUMMARY OF THE INVENTION

It is an object of the invention to provide a relief valve for an oil filter and an oil filter, whose assembly and disassembly is easy to perform manually by an operator.

A first aspect of the invention relates to a relief valve for an oil filter capable of separating an upstream side and a downstream side of a filter body, and furthermore, communicating the upstream side and the downstream side of the relief valve depending on the pressure difference between the upstream side and the downstream side. This relief valve is provided with a valve seat having an open portion communicating the upstream side with the downstream side, a valve body capable of closing the open portion, a spring energizing the valve body in a direction which closes the open portion, and a spring receiving body disposed such that the spring is interposed between the spring receiving body and the valve seat. The valve body has an engaging portion, and furthermore, the spring receiving body has an engageable portion that is selectively engageable and disengageable with respect to the engaging portion of the valve body.

The relief valve according to the first aspect of the invention, in an assembled state, can maintain engagement between the engageable portion of the spring receiving body and the engaging portion of the valve body using the spring for energizing the valve body. In addition, it is possible to assemble and disassemble the valve body, the valve seat, the spring and the spring receiving body by engaging and disengaging the engaging portion of the valve body and the engageable portion of the spring receiving body. Accordingly, a relief valve having advantages including ease of assembly and disassembly, and the like, is provided.

A second aspect of the invention relates to a relief valve for an oil filter capable of separating an upstream side and a downstream side of a filter body, and furthermore, communicating the upstream side and the downstream side of the relief valve depending on the pressure difference between the upstream side and the downstream side. This relief valve is provided with a valve seat having an open portion communicating the upstream side and the downstream side, a valve body capable of closing the open portion, and a leaf spring energizing the valve body toward a closing direction of the open portion. Furthermore, the valve body has an engaging portion, and the leaf spring has an engageable portion that is selectively engageable and disengageable with the engaging portion.

When the relief valve according to the second aspect of the invention is in an assembled state, it is possible to maintain engagement between an engaging portion of the valve body and an engageable portion of the leaf spring using energizing force of the leaf spring. In addition, it is possible to assemble and disassemble the valve body, the valve seat, and the leaf spring, by selectively engaging and disengaging the engaging portion of the valve body and the engageable portion of the leaf spring. Accordingly, a relief valve having advantages including ease of assembly and disassembly is provided.

Moreover, an oil filter provided with the relief valve, a filter body having an open portion closable by the relief valve, and a casing that houses the relief valve and the filter body, is also within the scope of the invention.

According to this oil filter, normally, the valve body energized in a closing direction by the spring (including the leaf spring) closes the open portion of the valve seat, and the oil is filtered by the filter body. On the other hand, if the pressure of the upstream side of the filter body is much higher than the pressure of the downstream side, the valve body is displaced in an opening direction resisting the energizing force of the spring (including the leaf spring), and the oil is discharged by communication of the upstream side and the downstream side which by-passes the filter. Accordingly, problems including damage of the filter body caused by abnormal pressure difference between the upstream side and the downstream side are suppressed. In addition, an oil filter having advantages including ease of assembly and disassembly is provided.

### BRIEF DESCRIPTION OF THE DRAWINGS

The foregoing and further objects, features and advantages of the invention will become apparent from the following description of preferred embodiments with reference to the accompanying drawings wherein like numerals are used to represent like elements and wherein:

FIG. 1 is a side view of an oil filter according to the invention, of which half is a sectional view;

FIG. 2 is an explanatory view showing the operation of the oil filter;

FIG. 3 is a plan view of a relief valve according to a first embodiment;

FIG. 4 is a side view of the relief valve according to the first embodiment, of which half is a sectional view;

FIG. 5 is an exploded perspective view of the relief valve according to the first embodiment;

FIG. 6 is an explanatory drawing of an assembly operation of the relief valve according to the first embodiment;

FIG. 7 is also an explanatory drawing of the assembly operation of the relief valve according to the first embodiment;

FIG. 8 is a further explanatory drawing of the assembly operation of the relief valve according to the first embodiment;

FIG. 9 is another explanatory drawing of the assembly operation of the relief valve according to the first embodiment;

FIG. 10 is a plan view of the relief valve according to a modified example of the first embodiment;

FIG. 11 is a side view of the relief valve according to a modified example of the first embodiment, of which half is a sectional view;

FIG. 12 is a plan view of a relief valve according to a second embodiment;

FIG. 13 is a side view according to the second embodiment, of which half is a sectional view;

FIG. 14 is a plan view of a valve body according to the second embodiment;

FIG. 15 is a side view of the valve body according to the second embodiment;

FIG. 16 is a perspective view of the valve body according to the second embodiment;

FIG. 17 is a plan view of a relief valve according to a third embodiment;

FIG. 18 is a side view of the relief valve according to the third embodiment, of which half is a sectional view;

FIG. 19 is a plan view of a relief valve according to a forth embodiment;

FIG. 20 is a side view of the relief valve according to of the forth embodiment, of which half is a sectional view; and

FIG. 21 is an exploded perspective view of the relief valve according to the forth embodiment.

### DETAILED DESCRIPTION OF PREFERRED EMBODIMENTS

Hereinafter, preferred embodiments of the invention will be described in detail referring to the drawings.

First, an oil filter 1 related to the embodiments will be described. Furthermore, this oil filter 1 is a so-called “spin on type” oil filter, that is, for example, provided using, appropriate fixing means at a point of a circuit of an engine lubricating system of a vehicle such as an automobile. The oil filter is able to filter foreign matter such as dust, fragments of metal wear, or sludge, mixed within engine oil.

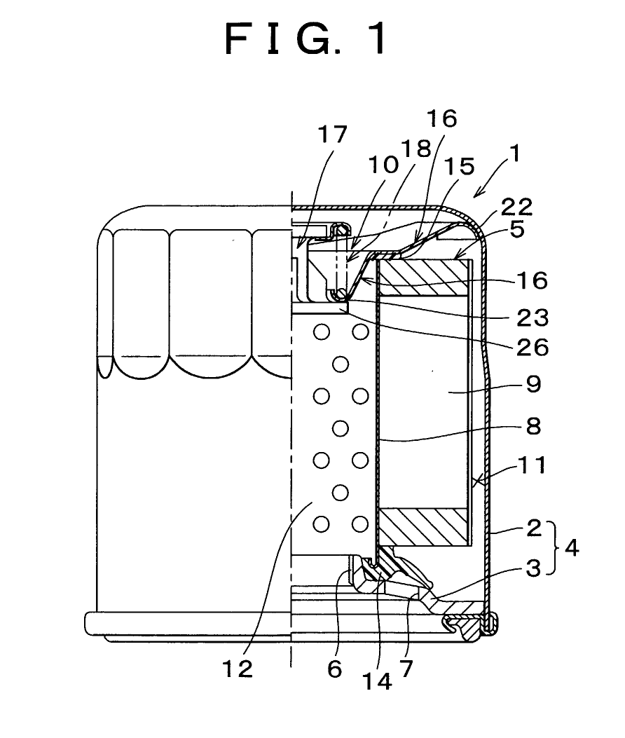

The oil filter 1 is fundamentally provided with a casing 4 composed by a bottomed tubular casing member 2 and a bottom plate 3 for closing an open portion at one end of the bottomed tubular casing member 2, a filter body 5 housed within the casing 4 and a relief valve 10 described later, as shown in FIG. 1.

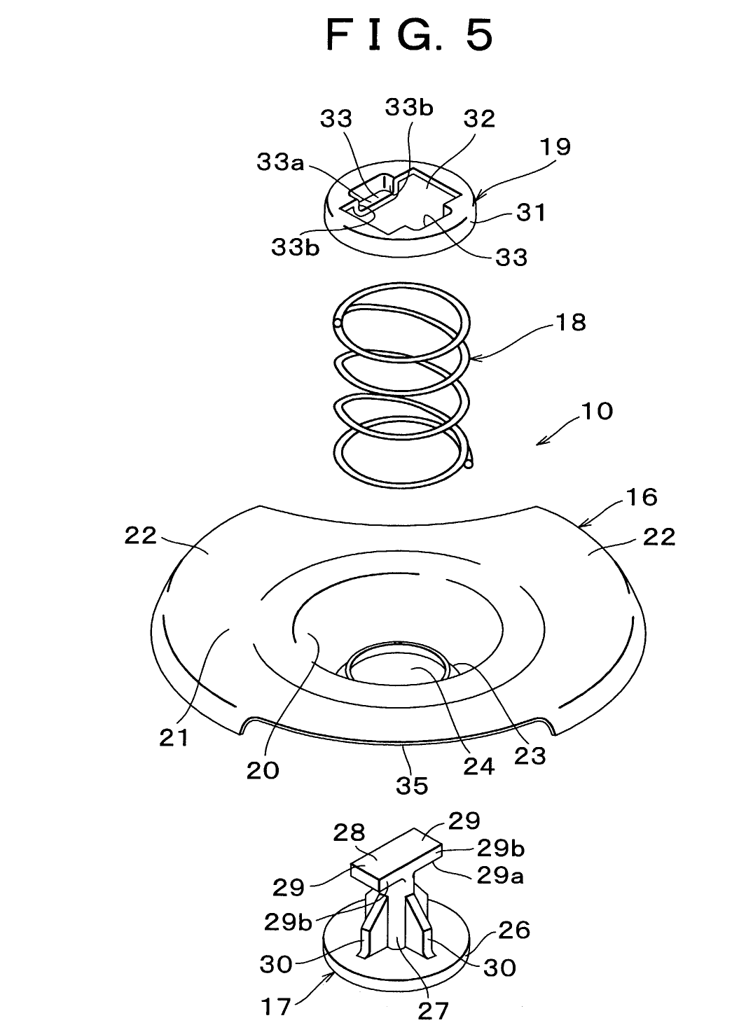

An oil outflow port 6 is formed in a center portion of the bottom plate 3 of the casing 4, and furthermore, a plurality of oil inflow ports 7 are formed at predetermined intervals of a circumferential direction of a periphery of the oil outflow port 6. Moreover, the filter body 5 is constructed by fitting a filter paper 9 having a folded shape to an outer periphery side of a metal tubular member 8 having a plurality of transmission holes. A top end open portion of the filter body 5 is closed by a relief valve 10, and the bottom plate 3 is inserted into a bottom end open portion of the relief valve 10. In addition, the filter body 5 is sandwiched between the bottom plate 3 and the relief valve 10 via a check valve 14 and a seal member 15, respectively. The filter body 5 is disposed coaxially with and in the case member 2. Moreover, the filter body 5 divides a space within the casing 4 into both an oil passage 11 that is connected to the oil inflow ports 7 and forming an upstream side of the filter body 5, and an oil passage 12 that is connected to the oil outflow port 6 and forming a downstream side of the filter body 5. Furthermore, as shown in FIG. 5, a valve seat 16 to be described later is provided with notched portion 35. The oil passage 11 extends as far as the space between the case member 2 and the valve seat 16.

(First Embodiment)

(1) Structure of the Relief Valve

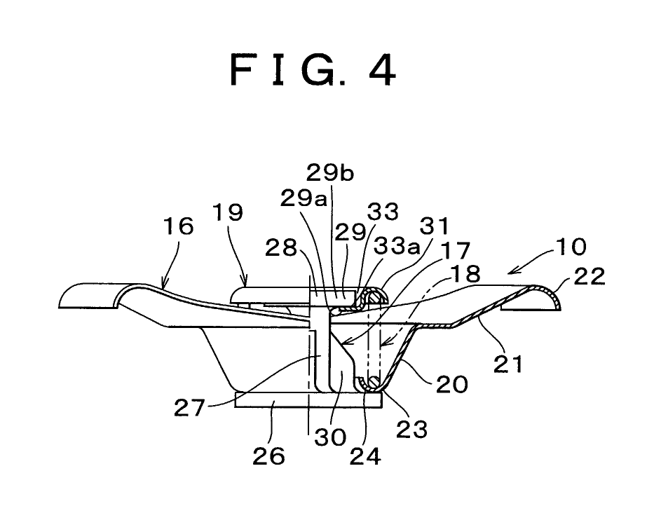

The relief valve 10 according to a first embodiment is shown in FIG. 3 to FIG. 5. As shown in FIG. 4 and FIG. 5, the relief valve is fundamentally provided with the metal plate valve seat 16 having an open portion 24 capable of direct communication of the oil passage 11 with the oil passage 12, a synthetic resin valve body 17 capable of closing the open portion 24, a cylindrical coiled spring 18 (which can be regarded as the spring according to the invention, and will hereinafter be simply referred to as “spring”) for energizing the valve body 17 toward a direction which closes the open portion 24, and a metal spring receiving body 19 disposed such that the spring 18 is interposed between the spring receiving body 19 and the valve seat 16.

As shown in FIG. 5, the valve seat 16 as a whole is formed into a reverse hat shape. This valve seat 16 is provided with a truncated conical cylindrical portion 20 having the open portion 24, a connecting portion 21 that is continuous to a periphery of a base tip side of the cylindrical portion 20 and extends in a curved and horizontal direction, and an R shaped abutting portion 22 abutting against a lower surface of the case member 2 and disposed at an outer edge side of the connecting portion 21. Furthermore, a circumferential edge of the cylindrical portion 20 is formed in an R shaped receiving portion 23. The receiving portion 23 is such that both external sides are capable of abutting against the valve portion 26 of the valve body 17 which is to be describe hereafter. In addition, the inner surface side of the receiving portion 23 receives a bottom edge side of the spring 18.

The valve body 17 is provided with the disk shaped valve portion 26 capable of closing the open portion 24 by abutting against the external sides of the receiving portion 23, a cylindrically shaped column portion 27 extending in an upward direction from a central portion of an upper surface of this valve portion 26, and a rectangular parallelepiped beam portion 28 provided at an upper end side of this column portion 27. A plurality of reinforcement ribs 30 (four are indicated in the figure) are provided at predetermined intervals (90° intervals are indicated in the figure) along a circumferential direction of a circumferential side of the column portion 27.

The spring 18 has an inner diameter larger than a plane of the beam portion 28 of the valve body 17. Accordingly, it is possible to insert without contact the spring 18 toward the beam portion 28 of the valve body 17, as will be described hereinafter.

According to the first embodiment a cylindrical spring is used as an example of the spring 18. However, the invention is not limited to this type of spring, and for example, a truncated conical coil spring or a barrel shaped coil spring may also be used.

The spring receiving body 19 as a whole is formed into an inverted saucer shape. The spring receiving body 19 is provided with a ring shaped receiving portion 31 for receiving a top edge side of the spring 18, an open portion 32 provided in an inside area of this receiving portion 31 and through which the beam portion 28 of the valve body 17 can be inserted within it with a predetermined amount of clearance, and a pair of recess portions 33 (which can be regarded as the engageable portion according to the invention) provided in a circumferential portion of a long side of the open portion 32, and capable of engagement with end portions 29 (which can be regarded as the engaging portion according to the invention) of the beam portion 28 of the valve body 17. Each recess portion 33 has a recess sloping downwards from a top end surface of the spring receiving body 19 in a downward direction, and furthermore, the opposing sides of the pair of recess portions 33 are open. In addition, the end portions 29 of the beam portion 28 are fitted into the recess portions 33 by inserting the beam portion 28 of the valve body 17 into the open portion 32 of the spring receiving body 19, and then rotating the valve body 17 by 90 degrees.

When the relief valve 10 is in an assembled state, a bottom surface 29a (which can be regarded as the engageable surface of the invention) of the end portions 29 of the longitudinal direction of the beam 28 of the valve body 17 is engaged and supported by a bottom surface 33a (which can be regarded as the engaging surface of the invention) of each recess portion 33. Moreover, mutual relative rotation and horizontal movement of the spring receiving body 19 and the valve body 17 are regulated, by positioning a side surface 33b of each recess portion 33 such that there is clearance from a side surface 29b (regulating surface) of the beam portion 28 of the valve body 17.

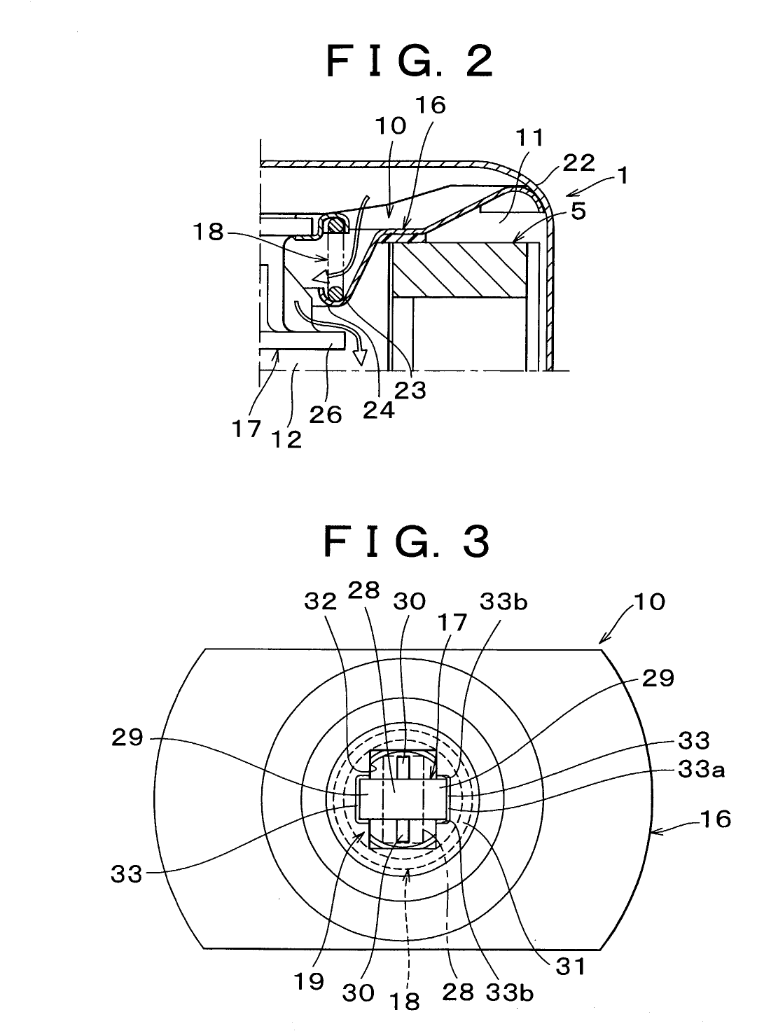

Furthermore, if the valve body 17 is displaced toward a opening direction resisting the energizing force of the spring 18, as will be described hereinafter, the valve portion 26 separates from the receiving portion 23 of the valve seat 16, such that the open portion 24 of the valve seat 16, which is closed by the valve portion 26, is opened (refer to FIG. 2).

(2) Method of Assembling and Disassembling the Relief Valve

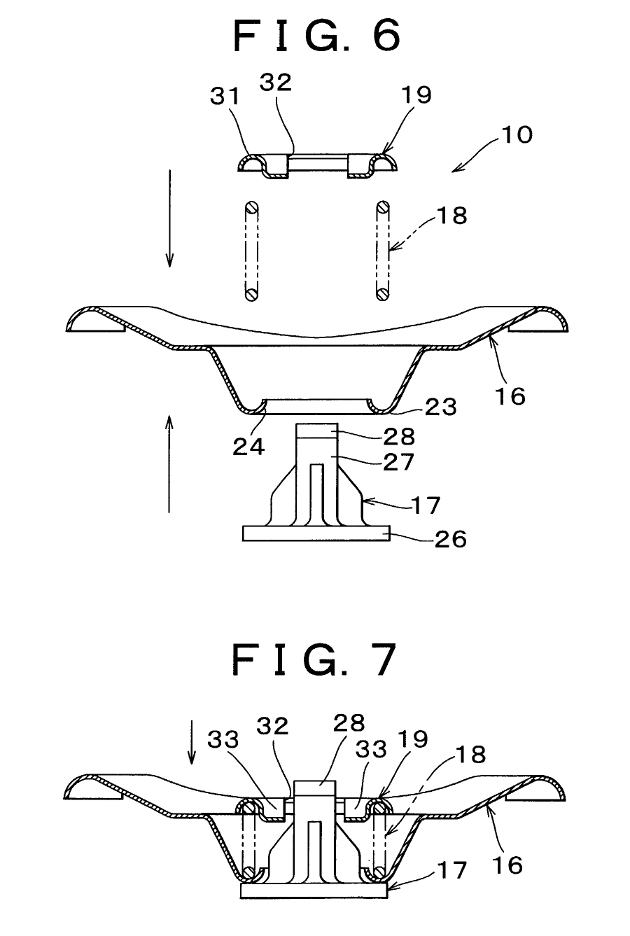

First, as shown in FIG. 6, the beam portion 28 and the column portion 27 of the valve body 17 are inserted in the open portion 24 of the valve seat 16, such that the receiving portion 23 of the valve seat 16 abuts against both upper sides of the valve portion 26 of the valve body 17. In this state, the spring 18 is inserted toward the beam portion 28 and the column portion 27 of the valve body 17 such that the spring 18 is received by the receiving portion 23 of the valve seat 16. In this way, the spring 18 is disposed such that it surrounds the beam portion 28 and the column portion 27 of the valve body 17. Following this, the open portion 32 of the spring receiving body 19 is moved into alignment with the beam portion 28 of the valve body 17 (refer to the beam portion 28 shown by the hypothetical line in FIG. 3), such that the open portion 32 is facing the beam portion 28. As a result, the receiving portion 31 of the spring receiving body 19 is covered by the upper top edge of the spring 18.

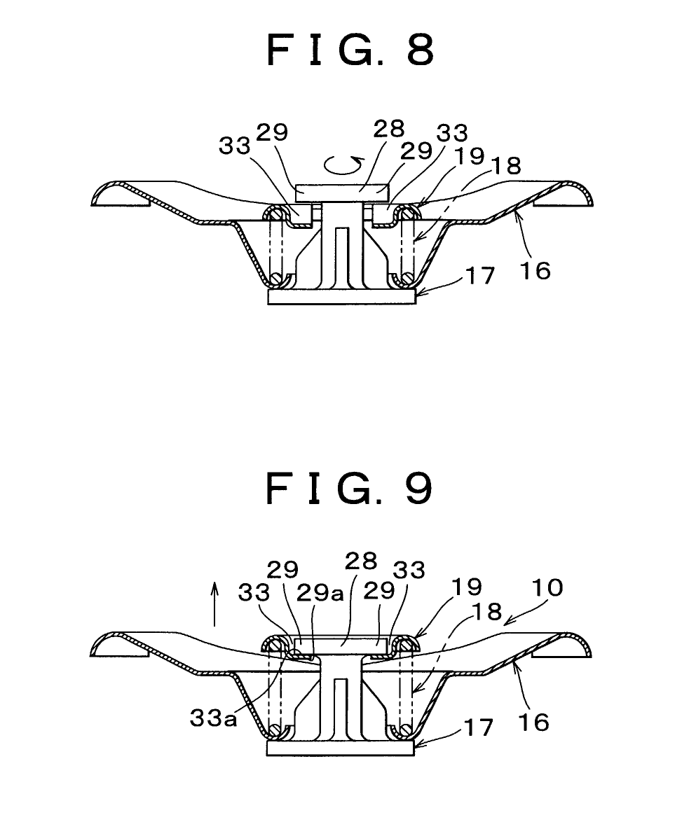

Next, as shown in FIG. 7, while the spring receiving body 19 is pushed downwards, the spring 18 is compressed and the beam portion 28 of the valve body 17 is inserted in the open portion 32 of the spring receiving body 19. The spring receiving body 19 is pushed downwards until positioned such that the upper surface of the spring receiving body 19 is slightly below the lower surface of the beam portion 28 of the valve body 17. Following this, as shown in FIG. 8, the valve body 17 is rotated approximately 90 degrees with respect to the spring receiving body 19, around an energizing direction of the spring 18, such that the end portions 29 of the beam portion 28 of the valve body 17 are horizontally opposed to the recess portions 33 of the spring receiving body 19 (refer to the beam portion 28 shown by solid lines in FIG. 3). In addition, as shown in FIG. 9, the spring receiving body 19 is pushed up by energizing force (restoring force) of the spring 18, such that the end portions 29 of the longitudinal direction of the beam portion 28 of the valve body 17 are fitted into the pair of recess portions 33 of the spring receiving body 19. By doing so, an engaged state of the four members, that is, the valve body 17, the valve seat 16, the spring 18 and the spring receiving body 19, is maintained by energizing force of the spring 18. In this way, assembly of the relief valve 10 is completed. After this, the oil filter 1 is assembled by housing the assembled relief valve 10 in the casing 4 along with the filter body 5, and so forth.

Furthermore, before disassembly and disposal of the oil filter 1, the assembled relief valve 10 is disassembled. This disassembly is conducted in the reverse order to the aforementioned assembly. Namely, first, the spring receiving body 19 is lowered down in a downward direction, resisting the energizing force of the spring 18 until the engagement of the end portions 29 of the beam portion 28 of the valve body 17 and the recess portions 33 of the spring receiving body 19 is released. In this state, the valve body 17 is rotated 90 degrees around the energizing direction of the spring 18 with respect to the spring receiving body 19, such that the beam portion 28 of the valve body 17 and the open portion 32 of the spring receiving body 19 are facing each other. The spring receiving body 19 is pushed up by energizing force of the spring 18, and the engaged state of the four members, that is, the valve body 17, the valve seat 16, the spring 18 and the spring receiving body 19, is released. Thus, disassembly of the relief valve 10 is completed.

(3) Operation of the Relief Valve

In the oil filter 1, foreign matter, such as dust mixed within oil, is removed by the filter body 5 from oil inflowing in the oil passage 11 which has inflowed through the oil inflow ports 7 of the bottom plate 3 due to the action of a pump (not shown in the figure), or the like. In addition, the oil that has had foreign matter removed is fed from the oil passage 12 to an engine lubricating system circuit outside of the oil filter 1 through the oil outflow port 6 of the bottom plate 3.

Furthermore, normally, in the relief valve 10, the oil passage 11 and the oil passage 12 are completely separated due to maintenance of an abutting state of the upper surface of the valve portion 26 of the valve body 17 and the receiving portion 23 of the valve seat 16, resulting from the energizing force of the spring 18. Alternatively, if the filter body 5 is blocked to a given extent or more by dust, or the like, contained within the oil, or if high-viscosity oil flows there within, a pressure difference between the oil passage 11 and the oil passage 12 equal to or above a predetermined value occurs, and the valve body 17 is pushed downwards by this pressure difference, resisting the energizing force of the spring 18 as shown in FIG. 2. When the valve body 17 is pushed downwards, the valve portion 26 of the valve body 17 and the receiving portion 23 of the valve seat 16 are separated, and the open portion 24 communicating the oil passage 11 with the oil passage 12 opens. As a result, the oil within oil passage 11 flows directly into the oil passage 12 without passing through the filter body 5, as shown by the arrows in the figure.

(3) Effects of the Embodiment

In the relief valve 10 according to the first embodiment, the spring 18 is interposed between the valve seat 16 and the spring receiving body 19, such that the recess portions 33 and the beam portion 28 of the valve body 17 are selectively engageable and disengageable. If the relief valve is structured like this, in an assembled state, it is possible to maintain an engaged state of the beam portion 28 of the valve body 17 and the recess portions 33 of the spring receiving body 19, using the energizing force of the spring 18 which resists the valve body 17. In addition, with such a relief valve, it is possible to reduce the number of parts that are necessary to maintain engagement of the valve body 17 and the spring receiving body 19, as compared to a relief valve provided with a specialist means to maintain engagement. Moreover, when the relief valve 10 according to the first embodiment is in an assembled state, the beam portion 28 of the valve body 17 is fitted so as to be engaged with the recess portions 33 of the spring receiving body 19. As a result, relative rotation and horizontal movement of the valve body 17 and the spring receiving body 19 are regulated, and reliable and strong engagement of both members, that is, the valve body 17 and the spring receiving body 19, can be maintained.

Furthermore, when disassembling the relief valve 10 according to the first embodiment, the distance between the valve body 17 and the spring receiving body 19 is reduced resisting the energizing force of the spring 18, and following this, the valve body 17 and the spring receiving body 19 are relatively rotated, thus releasing engagement of the beam portion 28 of the valve body 17 and the recess portions 33 of the spring receiving body 19. In this way, it is possible to rapidly disassemble the four members, that is, the valve body 17, the valve seat 16, the spring 18 and the spring receiving body 19, by energizing force of the spring 18. Accordingly, disassembly of the relief valve can be conducted with extreme rapidness and easiness, as compared to a relief valve in which the spring is removed while avoiding catching on the engagement hook portions of the valve body, while the column portions of the valve body are forcibly bent by fingertip manipulation of the operator. In particular, the inner diameter of the spring 18 is set such that it is greater than size of the beam portion 28, when looked at from an axial direction of the column portion 27. Moreover, the spring 18 is disposed such that it surrounds the column portion 27 of the valve body 17, when the relief valve is in an assembled state. As a result, when assembling and disassembling the relief valve 10, it is possible to easily attach and remove the spring 18 with respect to the valve body 17 without the beam portion 28 of the valve body 17 contacting with the inside of the spring 18.

Moreover, in the oil filter 1 adopting the relief valve 10 according to the first embodiment, if the pressure difference between the oil passage 11 and the oil passage 12 is equal to or above a predetermined valve, the open portion 24 of the valve seat 16 opens due to the valve body 17 being pushed up, and the oil within the oil passage 11 flows directly into the oil passage 12 without passing through the filter body 5. As a result, it is impossible for the pressure difference between the oil passage 11 and the oil passage 12 to reach an abnormal level which is equal to or above the predetermined value. Accordingly, it is possible to prevent problems such as damage of the filter body 5.

Furthermore, the relief valve 10 according to the first embodiment is such that the valve body 17 and the spring receiving body 19 can be selectively engaged and disengaged by engagement and disengagement of the engaging portions (the end portions 29 of the beam portion 28) and the engageable portions (the pair of recess portions 33) which are in two locations. However, the structure of the invention is not limited to this, and may be realized through engagement and disengagement of the engaging portions and the engageable portions in one location or three or more locations.

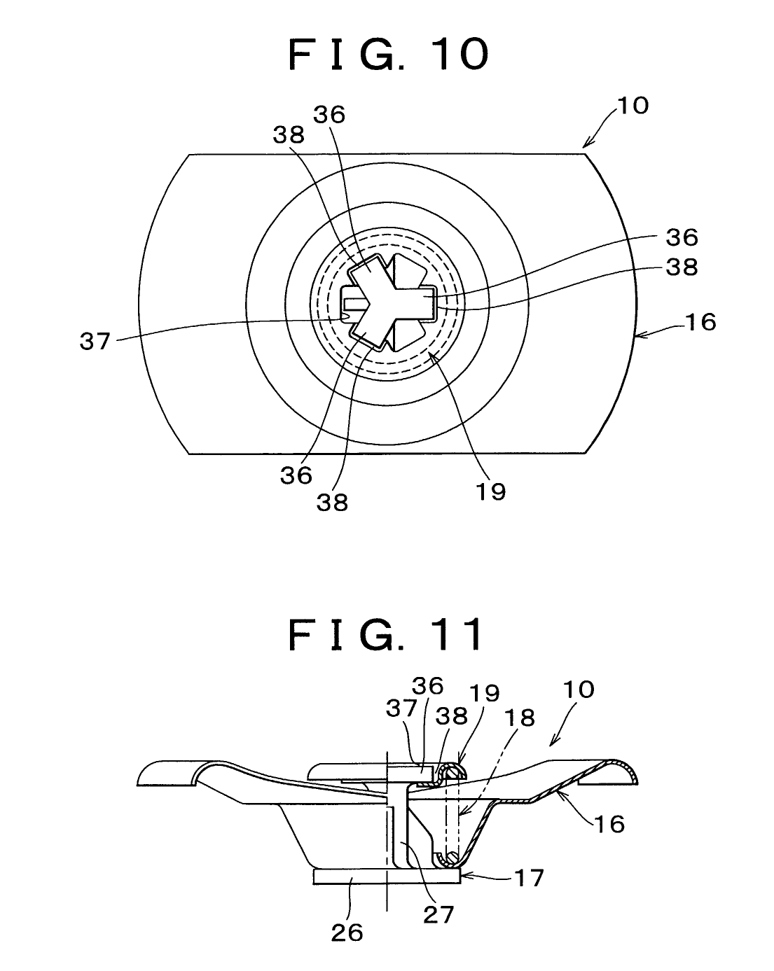

For example, as shown in FIG. 10 and FIG. 11, three engagement hook portions 36 (which can be regarded as the engaging portions of the invention) are provided at intervals of 120 degrees in a circumferential direction and extend in a radial direction with column portion 27 as an axial center. In addition, as well as the open portion 37, through which each engagement hook portion 36 is insertable, which is provided in the spring receiving body 19, three recess portions 38 (which can be regarded as the engageable portion according to the invention) corresponding to each engagement hook portion 36 are provided in the circumferential side of this open portion 37. This structure has the advantage that even if one of the engagement hook portions 36 is damaged, a state of engagement of the valve body 17 and the spring receiving body 19 can be maintained by the other two engagement hook portions 36.

Furthermore, although the spring 18 is adopted as the spring of the relief valve 10 according to the first embodiment of the invention as an example, the invention is not limited to this and may be realized through, for example, a leaf spring (including a coned disc spring) or an air spring. Moreover, during the assembly of the relief valve 10 according to the first embodiment, the column portion 27 of the valve body 17 is disposed such that the column portion 27 is surrounded within the inside of the spring 18. However, the invention is not limited to this and may be realized, for example, such that the column portion 27 of the valve body 17 is disposed outside of the spring 18. In addition, in the relief valve 10 according to the first embodiment, the beam portion 28 of the valve body 17 and the recess portions 33 of the spring receiving body 19 are selectively engaged and disengaged at the upper surface side of the spring receiving body 19, by inserting the beam portion 28 of the valve body 17 into the open portion 32 of the spring receiving body 19. However, the invention is not limited to this and may be realized, for example, such that an engageable surface is provided in the lower surface side of the spring receiving body without forming an open portion, and the engaging portion of the valve body and the engageable portion of the spring receiving body are engaged and disengaged at the lower surface side of the spring receiving body.

Next, alternative embodiments of the relief valve according to the invention will be described. Like reference numerals are used to denote like members of these structures that are substantially the same as the aforementioned first embodiment.

(Second Embodiment)

(1) Structure of the Relief Valve

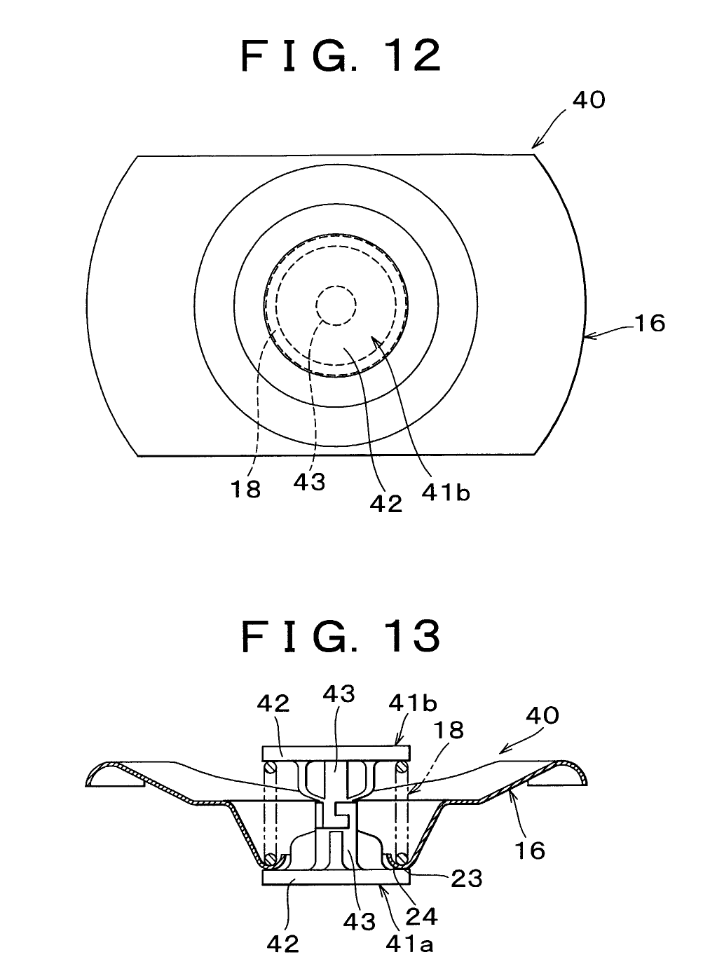

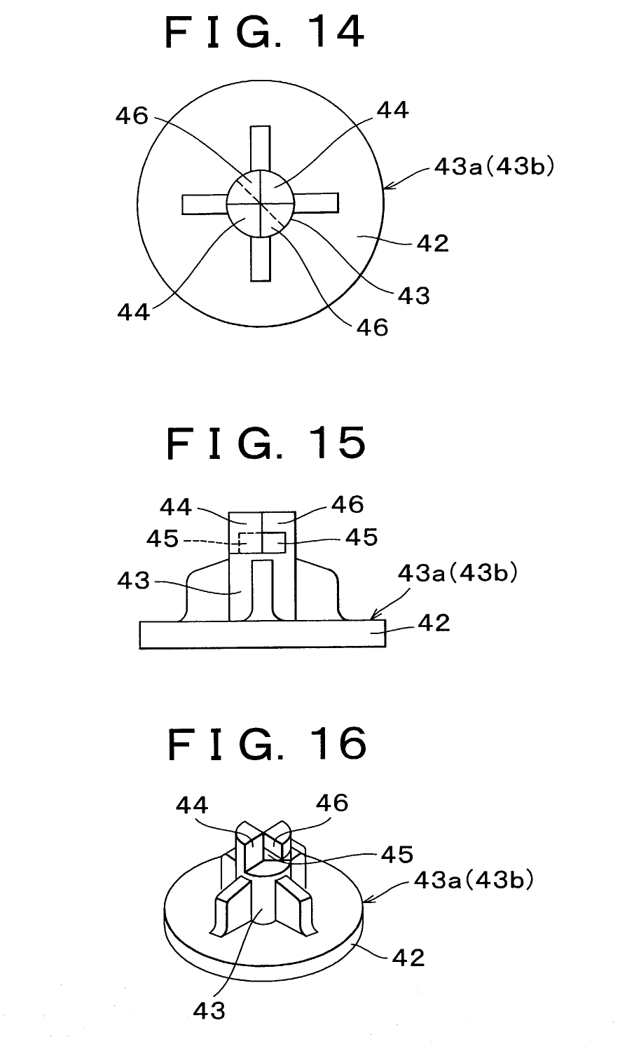

A relief valve 40 according to a second embodiment, is composed of a valve body 41a and a spring receiving body 41b having the same shape, as shown in FIG. 12 and FIG. 13. This valve body 41a (and the spring receiving body 41b) is provided with a valve portion 42, and a column portion 43 extending vertically from a central portion of the valve portion 42, as shown in FIG. 14 to FIG. 16. A pair of first notched portions 44 are formed extending in a downward direction from an upper end of the first notched portions 44, on an upper end side of this column portion 43. A pair of second notched portions 45 (which can be regarded as the engageable portion according to the invention) are formed such that they continue from a lower portion of each first notched portion 44 and extend in a circumferential direction. Moreover, a pair of hooked portions 46 (which can be regarded as the engaging portion according to the invention) are formed in an upper part of each second notched portions 45.

(2) Method of Assembling and Disassembling the Relief Valve

The column portion 43 of the valve body 41 a structured as aforementioned is inserted in the open portion 24 of the valve seat 16, such that the lower edge side of the spring 18 is received by the receiving body 23 of the valve seat 16. In this way, the spring 18 is disposed such that it surrounds the column portion 43 of the valve body 41 a. Moreover, the column portion 43 of the spring receiving body 41b structured as aforementioned is horizontally opposed with respect to the column portion 43 of this valve body 41a, such that the valve portion 42 of the spring receiving body 41b is placed onto the top edge side of the spring 18. Following this, the spring receiving body 41b is pushed down resisting energizing force of the spring 18, such that a tip side of the hooked portions 46 abuts against a bottom surface of the first notched portion 44 between the spring receiving body 41b and the valve body 41a. While this state is maintained, both the valve body 41a and the spring receiving body 41b are rotated approximately 45 degrees relative to each other in a circumferential direction, such that each hooked portion 46 meshes with each corresponding second notched portion 45. In this way, the assembly of the relief valve 10 is completed.

Moreover, during disassembly, the valve body 41a and the spring receiving body 41b are rotated approximately 45 degrees relative to each other in the opposite direction as to assembly, such that engagement of the hooked portions 46 and the second notched portions 45 is released. By doing so, disassembly of the four members, that is, the valve body 41a, the spring receiving body 41b, the valve seat 16 and the spring 18, is completed. Using the above configuration, the valve body 41a and the spring receiving body 41b of the relief valve 10 have the same structure and thus reduction costs can be reduced.

(Third Embodiment)

(1) Structure of the Relief Valve

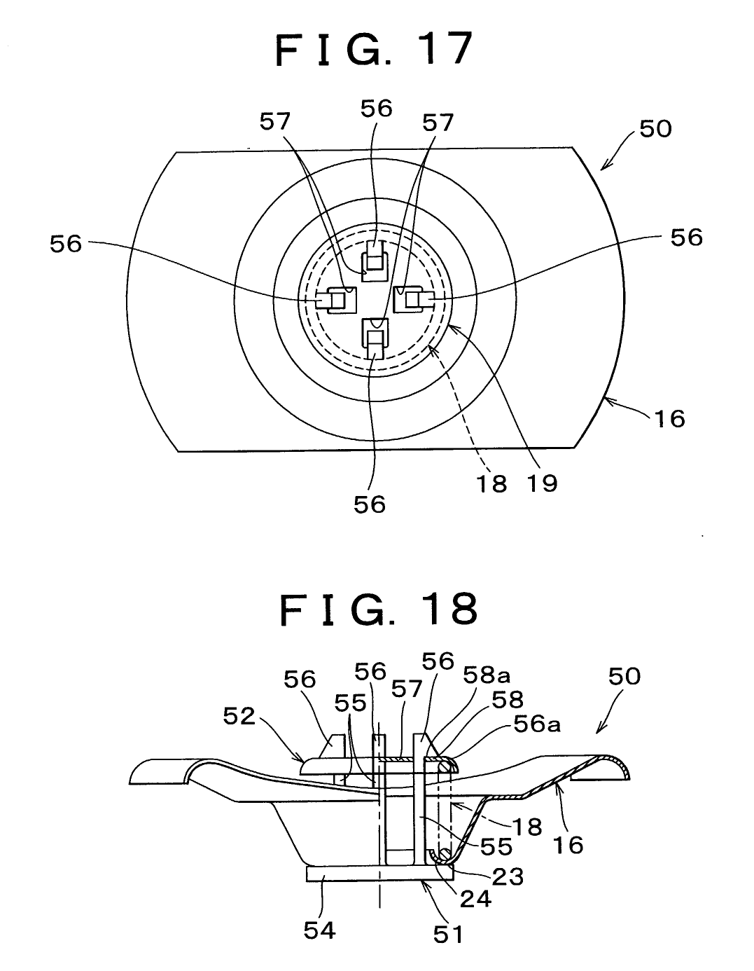

A relief valve 50 according to a third embodiment, as shown in FIG. 17 and FIG. 18, is a push lock type such that an engaging portion of a valve body 51 and an engageable portion of a spring receiving body 52 are engaged and disengaged by relative movement of the valve body 51 and the spring receiving body 52 along with elastic deformation in line with the energizing direction of the spring 18. This valve body 51 is provided with a valve portion 54, a plurality (four are shown in the figure) of elastically deformable support portions 55 extending vertically from the valve portion 54, and engagement hook portions 56 (which can be regarded as an engaging portion according to the invention) provided on a tip side of each support portion 55, protruding outwards. Moreover, the spring receiving body 52 has a plurality (four) of open portions 57 that are insertable in each engagement hook portion 56. A hook surface 56a (which can be regarded as the engaging surface according to the invention) of each engagement hook portion 56 engages and disengages from an upper surface 58a (which can be regarded as the engageable surface according to the invention) of a circumferential portion 58 of each of these open portions 57. In addition, the inner diameter of the spring 18 is set to a value such that all of the engagement hook portions 56 are insertable.

(2) Method of Assembling and Disassembling the Relief Valve

The engagement hook portions 56 and the support portions 55 of the valve body 51 structure as aforementioned are inserted into the open portion 24 of the valve seat 16, such that lower edge side of the spring 18 is received by the receiving body 23. In this way, the spring 18 is disposed such that it surrounds the support portions 55 of the valve body 51. In addition, the spring receiving body 52 covers the top edge side of the spring 18 such that each of these open portions 57 is horizontally opposed to each engagement hook portion 56. If the spring receiving body 52 is pushed downwards resisting energizing force of the spring 18, the engagement hook portions 56 are inserted within the open portions 57 while the support portions 55 are bent. Following this, the engagement hook portions 56 catch on the circumferential portion 58 of the open portions 57, and the assembly of the relief valve 10 is completed.

Furthermore, during disassembly, the procedure is performed in the reverse order to the aforementioned assembly. The operator holds each engagement hook portion 56 by hand and removes it from the open portions 57 while forcibly bending each support portion 55. By doing so, disassembly of the four members, that is, the valve body 51, the spring receiving body 52, the valve seat 16 and the spring 18, is completed. As a result of this structure, disassembly of the relief valve 10 can be conducted rapidly and with great ease, as compared to a relief valve in which a spring is removed while avoiding catching on the engagement hook portions of the valve body, while the column portions of the valve body are forcibly bent by fingertip manipulation of the operator.

(Fourth Embodiment)

(1) Structure of the Relief Valve

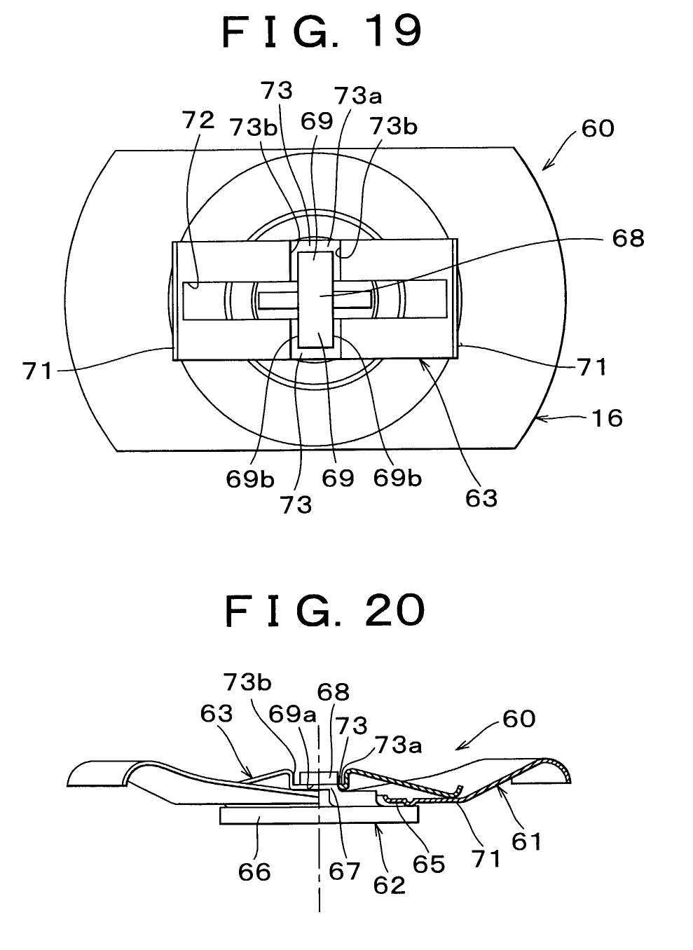

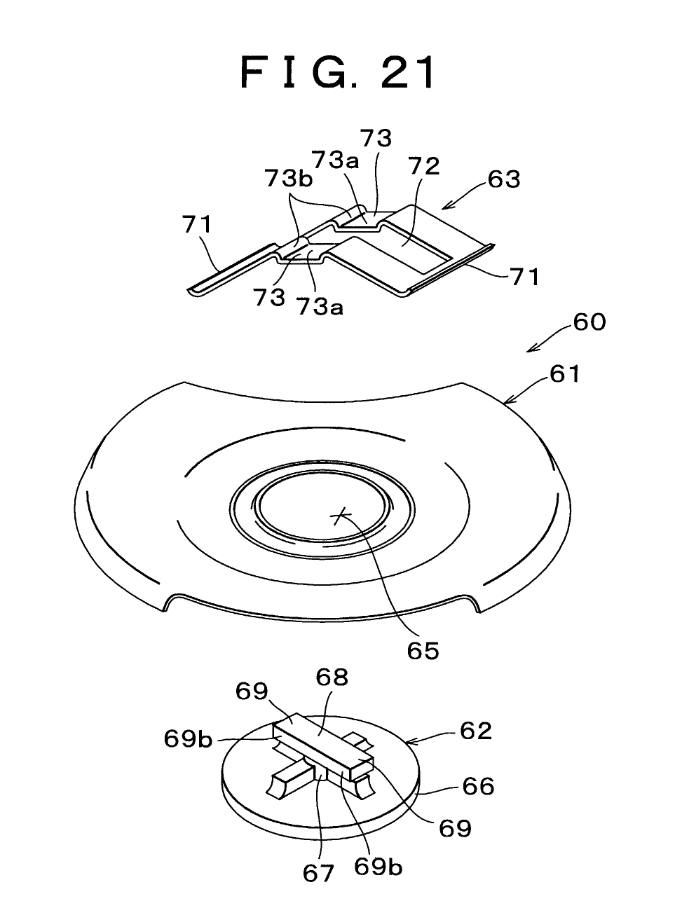

A relief valve 60 according to a fourth embodiment, as shown in FIG. 19 to FIG. 21, is fundamentally provided with a metal plate valve seat 61 having an open portion 65, a synthetic resin valve body 62 capable of closing this open portion 65, and a leaf spring 63 having a cross section which is substantially a W shape that energizes this valve body 62 in a closing direction of the open portion 65. The valve body 62 is provided with a valve portion 66, a column portion 67 that extends vertically from this valve portion 66, and a rectangular parallelepiped beam portion 68 provided on an upper end side of this column portion 67. This beam portion 68 has end portions 69, that can be regarded as the engagement portion according to the invention.

The leaf spring 63 is provided with a left and right pair of abutting portions 71 that abut against an upper surface of the valve seat 61, an open portion 72 through which the beam portion 68 of the valve body 62 can be inserted with a predetermined amount of clearance and which is disposed between the abutting portions 71, and a pair of recess portions 73 (which can be regarded as the engageable portion according to the invention) provided on a circumferential portion of the long side of the open portion 72 which can be fitted such that they engage with the end portions 69 of the beam portion 68 of the valve body 62. When the relief valve 60 is in an assembled state, engagement is maintained of bottom surfaces 73a (which can be regarded as the engageable surface according to the invention) of the recess portions 73 of the leaf spring 63 with a bottom surface 69a (which can be regarded as the engaging surface according the invention) of the end portions 69 of the longitudinal direction of the beam portion 68 of the valve body 62. Moreover, a side surface 73b (regulating surface) of each recess portion 73 of the leaf spring 63 positions a side surface 69b (regulated surface) of the beam portion 68 of the valve body 62, thus regulating mutual relative rotation and horizontal movement of the leaf spring 63 and the valve body 62.

Furthermore, in the fourth embodiment a flat spring constituted from a single thin sheet is adopted as an example of the leaf spring 63. However, the invention is not limited to this and may be realized through, for example, a laminated spring constituted from a plurality of sheets or a coned disc spring.

(2) Method of Assembling and Disassembling the Relief Valve

First, the beam portion 68 and the column portion 67 of the valve body 62 are inserted into the open portion 65 of the valve seat 61. Next, the open portion 72 of the leaf spring 63 is inserted toward the beam portion 68 of the valve body 62, and the leaf spring 63 is pushed downwards until the top face of the leaf spring 63 is disposed below the bottom face of the beam portion 68. While this state is maintained, the valve body 62 and the leaf spring 63 are rotated approximately 90 degrees relative to each other and thus the beam portion 68 of the valve body 62 is fitted so as to be engaged with the pair of recess portions 73 of the leaf spring 63 by energizing force of the leaf spring 63. By doing so, the assembly of the relief valve 60 is completed.

Furthermore, during disassembly, the procedure is performed in the reverse order to the aforementioned assembly. The leaf spring 63 is pushed downwards thus removing the beam portion 68 of the valve body 62 from the recess portions 73 of the leaf spring 63, and while this state is maintained, the valve body 62 and the leaf spring 63 are rotated approximately 90 degrees relative to each other. By doing so, engagement of the leaf spring 63 and the valve body 62 is released, and the three elements—the valve body 62, the valve seat 61 and the leaf spring 63—are disassembled. As a result of providing the leaf spring 63 with the recess portions 73 that are selectively engageable and disengageable with the beam portion 68 of the valve body 62, it is possible to omit the spring receiving body that is adopted in the first to third embodiments. As a result, the fourth embodiment has advantages over these embodiments, such as a reduced number of parts, and the like.

What is claimed is:

1. A relief valve for an oil filter, comprising:
a filter body that filters oil; and
a valve seat having an open portion that communicates an upstream side and a downstream side of the filter body; and
a valve body having an engaging portion which is capable of closing the open portion; and
a spring energizing the valve body in a direction which closes the open portion such that the upstream side and the downstream side of the filter body are separated, and being capable of displacing the valve body in a direction which opens the open portion depending on a pressure difference between the upstream side and the downstream side of the filter body; and
a spring receiving body having an engageable portion that is selectively engageable and disengageable with the engaging portion, which is disposed such that the spring is interposed between the spring receiving body and the valve seat.

2. The relief valve according to claim 1, wherein the spring is a coiled spring having an inner diameter through which at least one of the engaging portion and the engageable portion is insertable.

3. The relief valve according to claim 1, wherein
the engaging portion has an engagement surface orthogonal to an energizing direction of the spring, and
the engageable portion has an engageable surface that is selectively engageable and disengageable with the engaging surface by relative rotation of the valve body and the spring receiving body around the energizing direction of the spring.

4. The relief valve according to claim 1, wherein
the valve body comprises a valve portion for closing the open portion; and a column portion extending in one direction from the valve portion,
the engaging portion is provided on an end portion of the column portion,
the spring receiving body comprises a receiving portion for receiving the spring, and an open portion provided on an inner side of the receiving portion and through which the engaging portion is insertable, and
the engageable portion is provided at a periphery of the opening.

5. The relief valve according to claim 1, wherein the valve body and the spring receiving body have the same shape.

6. The relief valve according to claim 1, wherein the valve body has elastically deformable support portion for supporting the engaging portions; the engaging portion has an engagement surface orthogonal to an energizing direction of the spring; the engageable portion has an engageable surface that is selectively engageable and disengageable with the engaging surface due to relative movement of the valve body and the spring receiving body in the energizing direction of the spring, along with elastic deformation of the support portion.

7. A relief valve for an oil filter, comprising:
a filter body that filters oil;
a valve seat having an open portion that communicates an upstream side and a downstream side of the filter body;
a valve body having an engaging portion which is capable of closing the open portion; and
a leaf spring energizing the valve body in a direction which closes the open portion such that the upstream side and the downstream side of the filter body are separated, being capable of displacing the valve body in an opening direction of the open portion depending on a pressure difference between the upstream side and the downstream side of the filter body, and having an engagable portion that is selectively engageable and disengageable with the engaging portion.

8. The relief valve according to claim 7, wherein
the engaging portion has an engaging surface orthogonal to an energizing direction of the leaf spring; and
the engageable portion has an engagement surface that is selectively engageable and disengageable with the engaging surface by relative rotation of the valve body and the leaf spring around the energizing direction of the leaf spring.

9. The relief valve according to claim 8, wherein
the valve body comprises a valve portion for closing the open portion; and a column portion extending in one direction from the valve portion,
the engaging portion is provided at end portions of the column portion,
the leaf spring comprises an abutting portion that abuts against the valve seat; and an open portion through which the engaging portion is insertable, and
the engageable portion is provided in a periphery of the open portion.

10. An oil filter comprising:
the relief valve according to claim 1; the filter body having an open portion closable by the relief valve; and a casing housing the relief valve and the filter body.

11. An oil filter comprising:
the relief valve according to claim 7; the filter body having an open portion closable by the relief valve; and a casing housing the relief valve and the filter body.
